(19) United States
(12) Patent Application Publication
(10) Pub. No.: US 2007/0001638 A1
(43) Pub. Date: Jan. 4, 2007

(54) Robot with vibration sensor device

(75) Inventors: Charles Gray, Caddo Mills, TX (US); Conrad Seymour, Richardson, TX (US); Susan Dyer, Plano, TX (US); David L. Adams, Plano, TX (US)

Correspondence Address: KAGAN BINDER, PLLC, SUITE 200, MAPLE ISLAND BUILDING, 221 MAIN STREET NORTH, STILLWATER, MN, 55082, US

(73) Assignee: FSI INTERNATIONAL, INC.

(21) Appl. No.: 11/473,392

(22) Filed: Jun. 23, 2006

Related U.S. Application Data
(60) Provisional application No. 60/696,099, filed on Jul. 1, 2005.

(51) Int. Cl. G05B 19/19; B25J 9/18

(52) U.S. Cl. 318/568.11

(57) ABSTRACT

Methods and apparatuses for calibrating and teaching a robot to accurately work within a work environment are described. The present invention preferably provides one or more vibration sensor devices operatively coupled with a robot. In one aspect of the present invention a method comprises the steps of providing a vibration sensitive detector on a robot end effector, causing the end effector to contact an object, generating a signal indicative of the position of the contact with respect to the end effector, and using information comprising the generated signal to teach the robot the location of the contact in the work environment.

This application claims the benefit of U.S. Provisional Application Ser. No. 60/696,099 filed on Jul. 1, 2005, entitled “ROBOT WITH VIBRATION SENSOR DEVICE,” which application is incorporated herein by reference in its entirety.

### FIELD OF THE INVENTION

The present invention relates to robotic handling systems. In particular, the present invention is directed to apparatuses and methods for transferring objects between various locations within a work environment wherein a vibration sensor is used to calibrate positional relationships.

### BACKGROUND OF THE INVENTION

In fabricating typical microelectronic devices, certain objects are often transferred between various locations within a work environment by robotic handling systems. These objects frequently include substrates or wafers for forming microelectronic devices. They may be substrates including partially or fully completed microelectronic devices, cassettes or other carriers, or other objects needed to be moved between different locations. The robots used must be able to pick up objects from a particular location such as a cassette or other carrier, processing station, another robot, or an entry/exit station, and then transfer them to a desired location. Usually, these robots include an end effector mounted to an end of a robot arm to facilitate transfer of such objects. These transfers desirably take place without crashing the robot or damaging the objects and are desired to occur quickly so as to maximize production throughput. In other words, rapid and accurate robot movements are desired. In order to perform these transfers, the robot generally needs to accurately know the spatial coordinates of at least some portion of an end effector and/or other components with respect to the spatial coordinates of the pickup and destination positions.

Generally, a robot body is fixed to a base support and an articulated robot arm is cantilevered from the robot body. The robot arm includes a first arm section pivotably attached to a second arm section. A wand or end-effector, whose outer end is generally y-shaped with spaced apart fingers, is pivotably attached to the second arm section. Vacuum ports, or edge gripping mechanisms, are usually provided on the end effector, which enable it to retain a wafer in order to pick up and transport the wafer from a cassette to a process station and vice-versa. In other instances, the robot base is not fixed but rather is moveable along track(s) or the like.

Robot mechanisms can have one or multiple degrees of freedom. The number of degrees of freedom of a robot corresponds with the number of independent position variables that must be specified to locate all parts of the mechanism. For example, robotic systems having three degrees of freedom have been used because of their relative simplicity. One such three-axis robot is described in U.S. Pat. No. 6,242,879 to Sagues et al. The Sagues et al. robot has three axes of movement, which allow the robot to move in the radial (R), angular or theta (Θ), and vertical (Z) directions.

More complex robotic systems having six or more degrees of freedom are utilized as well. In most robots, the links of the robot form an open kinematic chain, and because each joint position is usually defined with a single variable, the number of joints corresponds with the number of degrees of freedom. As such, robots with 6 or more degrees of freedom can move in x, y, z, yaw, pitch, and roll.

In typical systems, the general geometry of the robot and the various process stations is known. That is, the approximate dimensional relationships between the robot and each location of interest are known, within nominal tolerances, from design specification or physical measurements. Generally, however, such information may not be accurate enough to assure that the robot can operate properly without damaging any systems component or the objects being handled. In order to assure the close tolerances required for the necessary precision during object transfer, a robot positioned within a working environment is usually taught where certain locations of the environment are. This teaching can be manual, semi-automated, or fully automated. Robot teaching or robot calibration, if automated, is referred to as autoteaching or autocalibration. Additionally, whenever the system is serviced or a machine component wears, settles, or malfunctions and requires replacement, upgrade, or service, the robot must be re-taught positions relative to the modified component(s) because the robot cannot automatically adapt to such variations. If the robot is not re-taught properly within close tolerances, serious damage to the robot or loss of expensive objects such as wafers or objects can result.

Manual teaching typically occurs without the help of sensors on the robot and/or sensors distributed around the environment of the robot. Besides consuming many hours, manual teaching procedures can introduce subjectivity, and thus a significant possibility for errors. This creates a problem of reproducibility.

Thus, automated procedures would be more desirable in many applications. One example of an automated approach for teaching a wafer transfer robot can be found in U.S. Pat. No. 6,075,334 to Sagues et al. This patent purportedly describes a system for automatically calibrating a wafer handling robot so that the robot can move wafers among precise locations within the range of motion of the robot. The system includes a controller having memory and logic sections connected to a robot having an articulated arm that is movable in three degrees of movement. Dimensional characteristics of the robot wand and the enclosures are stored in the controller memory.

The robot of U.S. Pat. No. 6,075,334 uses a thin beam laser sensor, a continuous beam sensor, and a reflective LED sensor. These sensors are provided at each enclosure and/or the robot wand, which are activated and then provide signals to the controller that are relative to the wand position. The robot is programmed to execute a series of progressive movements at each enclosure location, which are controlled by a combination of sensor response signals and the appropriate dimensional characteristics. At the end of the programmed movements, the robot wand is positioned within a process station or cassette so that it can engage for removal or release an object therein at a precise predetermined location.

Another automated approach for teaching a wafer transfer robot can be found in U.S. Pat. No. 6,242,879 to Sagues et al. In this patent a method and apparatus for automatically calibrating the precise positioning of a wafer handling robot relative to a target structure is described. The apparatus includes a machine controller connected to a robot having an end-effector with three degrees of movement. The controller has a memory with stored approximate distance and geometrical data defining the general location of structural features of the target structure. The robot is programmed to move toward the target structure in a series of sequential movements, each movement culminating with the robot end-effector touching a preselected exterior feature of the target structure. Each touching of the end-effector is sensed by utilizing motor torque variations. This provides data for the controller, which then calculates the precise location of the target structure. The data accumulated during a series of touching steps by the robot end-effector is utilized by the controller to provide a precise calibrated control program for future operation of the robot.

The light beam sensor approach and the torque sensing approach described in U.S. Pat. No. 6,075,334 to Sagues et al. and U.S. Pat. No. 6,242,879 to Sagues et al. suffer from several limitations. In particular, both approaches can be difficult to utilize with robots having more than three degrees of movement as more degrees of motion generally require more numerous and complex sensing movements. Increased complexity of the sensing approach can be expensive and can introduce difficulties in calibration and teaching especially where precise sensing is not possible. Moreover, motor torque sensing is generally limited to single axis motion such as planar motion for teaching of slots of a cassette. Thus, this type of sensing cannot handle non-planar motion such as is required for accommodating multiple entry angles for certain cassettes or the like.

Methods and apparatuses useful for teaching and/or calibrating a robot to accurately work within a work environment are taught in US Patent Application Publication No. 2004-0078114-A1. In particular, the system described therein provides one or more tactile sensor devices that may be operatively coupled with a robot, such as on an end effector, and/or that may be positioned at one or more desired locations within a work environment.

### SUMMARY OF THE INVENTION

The use of a robot end effector comprising a vibration sensor device for robot teaching and calibration procedures can advantageously simplify many aspects of these procedures. For example, a robot end effector vibration sensor system comprising a control system that uses information comprising information from a vibration sensitive sensor can determine precise positional information within a coordinate system.

It is believed that any application wherein a robot interacts with a work environment can benefit from the inventive concept of the present invention. As a result, the choice of robot and work environment is not particularly limited. The invention is particularly suitable for robotic applications where a multi-axis robot operates within a defined environment and moves to or interacts with various locations, modules, or stations within the environment. It is believed that the present inventive concept will prove particularly advantageous when utilized with robots contemplated to handle fungible payloads such as substrates or wafers or carriers for such substrates. Robots for handling such objects typically find use in semiconductor processing applications.

In one aspect of the present invention a method of characterizing the vibration of a robot end effector when in motion and when contacting an object within a work environment of the robot is provided. This method comprises the steps of:

a) providing a vibration sensitive sensor on a robot end effector;

b) moving the robot end effector through a predetermined range of motion and measuring the observed vibration of the robot end effector at predetermined portions of this moving step b);

c) moving the robot end effector through a predetermined range of motion while causing the robot end effector to contact an object in the work environment of the robot, and measuring the observed vibration of the robot end effector at predetermined portions of moving and contacting step c);

d) comparing the observed vibration of step b) with the observed vibration of step c) and identifying one or more vibration frequencies to monitor to provide a signal indicative of the position of the contact of the robot end effector with the object without undue background noise from motion of the robot end effector.

In another aspect of the present invention, a method of teaching a robot a position within a work environment of the robot is provided. This method comprises the steps of:

providing a robot end effector that has been characterized in accordance with the method described above;

causing the robot end effector to contact an object in the work environment of the robot;

generating a signal indicative of the contact of the robot end effector with the object; and

recording the end effector position in a manner that can be translated to the robot's frame of reference at the occurrence of the contact using the recorded end effector position to teach the robot the location of the contact in its frame of reference.

In a preferred embodiment of this aspect of the invention, the object is contacted a plurality of times at a plurality of contact points to determine an object's location in the robot's frame of reference. This information is used to determine the robot's location and orientation in relation to the contacted object.

In another aspect of the present invention, a method of determining an adverse robot end effector motion event is provided. This method comprises the steps of:

i) providing a robot end effector that has been characterized in accordance with the method described above;

ii) causing the robot end effector to move through a predetermined range of motion in the work environment of the robot while monitoring the observed vibration of the robot end effector;

iii) comparing the observed vibration of the monitored motion of step ii above with the observed vibration of step b) of the characterizing step described above; and

iv) generating a signal indicative of a variance in the compared vibrations indicative of an adverse robot end effector motion event, and recording the end effector's position in a manner that can be translated to the robot's frame of reference at the occurrence of the event.

The adverse robot end effector motion event may be, for example, a collision of the robot end effector with an object in the work environment of the robot or a mechanical failure of the robot end effector.

In another aspect of the present invention, a robot end effector vibration sensor system for providing positional information about a movable robot end effector in a work environment of the robot is provided. This vibration sensor system comprises a robot having a robot end effector with a vibration sensitive sensor located thereon, the robot end effector having been characterized in accordance with the method described above; and a control system that uses information comprising information from the vibration sensitive sensor to determine the position of the robot end effector of the robot in the work environment of the robot.

In another aspect of the present invention, a vibration sensitive robot is provided. This robot comprises at least one robot end effector capable of being controllably moved within a work environment of the robot and at least one vibration sensor device positioned on the robot end effector of the robot, which vibration sensor device outputs a signal indicative of a contact of the robot end effector when contacting at least a portion of the work environment.

Additionally, in another aspect of the present invention, a robotic system is provided, the robotic system comprising;

a work environment;

a robot end effector vibration sensor system as described above, wherein the robot end effector is positioned at least partially within the work environment, wherein the robot end effector vibration sensor system is capable of providing information indicative of the position of at least a portion of the robot end effector of the robot in the work environment.

### BRIEF DESCRIPTION OF THE DRAWINGS

The accompanying drawings, which are incorporated in and constitute a part of this specification, illustrate several aspects of the invention and together with the description of the preferred embodiments, serve to explain the principles of the invention. A brief description of the drawings is as follows:

FIG. 1 is a top schematic view of a tool cluster for fabricating microelectronic devices and having a robot and several processing stations that can be used in combination with the present invention where the robot includes six degrees of freedom for the purposes of illustration;

FIG. 2 is a perspective view of the robot shown in FIG. 1 and showing in particular a vibration sensor device of the present invention positioned on an end effector of the robot; and

FIG. 3 is an exploded view of an alternative end effector of the present invention.

### DETAILED DESCRIPTION

The embodiments of the present invention described below are not intended to be exhaustive or to limit the invention to the particular embodiments disclosed in the following detailed description. Rather, the embodiments are described so that others, particularly those skilled in the art, can understand the principles and practices of the present invention. For example, while much of the disclosure below expressly discusses systems for handling wafers, the aspects and embodiments of the invention as herein described additionally provide benefit for handling of microelectronic devices such as LED screens or other such devices.

For certain applications, a vibration sensor device can accurately detect features (such as the reference structure described below) of a work environment (sometimes called a work cell or work envelope) by contacting such features and reporting positional information about the features, within a frame of reference of the vibration sensor device. The information may then be used in a suitable format and fashion, either directly or indirectly, to help determine positional information about the features within a frame of reference of the robot. Preferably, for instance, by causing the vibration sensor device to contact features of a work environment, the robot can accurately record the positions of desired features of a work environment.

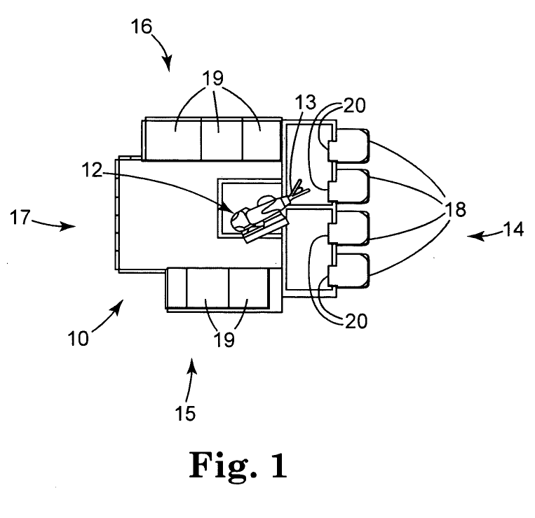

FIG. 1 schematically shows a representative tool cluster 10, such as the POLARIS® 2500 or POLARIS® 3500 series cluster tools available from FSI International, Inc., Chaska, Minn., and Allen, Tex. which, as shown, includes front 14, sides 15 and 16, and rear 17. The front 14 of tool cluster 10 is preferably provided with one or more interfaces 20 through which batches of substrates or wafers, typically carried in a suitable holder such as industry-standard front opening unified pods (FOUPs) 18, may be transported into and taken from tool cluster 10. For purposes of illustration, tool cluster 10 includes four such FOUPs 18. The tool cluster 10 also preferably includes modules 19, which may comprise stacks of functional units that can be used to house processing stations, controls, plumbing, supplies, and the like. Such modules 19 may also include for example, intro/exit stations, processing stations such as spin-coating stations, developing stations, thermal processing stations, stepper stations, wafer storage or staging stations, and the like.

Preferably, tool cluster 10 includes at least one robot 12 that utilizes an automatic calibration and teaching system embodying the principles of the present invention. As shown, the robot 12 is positioned within the tool cluster 10 such that an end effector 13 can reach the FOUPs 18 and modules 19 so that the robot 12 can move wafers in and out of the FOUPs 18 and to and from the modules 19. Thus, the robot 12 comprises many capabilities, including one or more of picking up wafers; transferring a wafer from one locale to another; releasing a wafer at a particular locale; mapping batches of wafers held vertically, horizontally, or otherwise in a wafer carrier; autoteaching or autocalibration of wafer exchange positions relative to the robot 12; and the like. It is noted that the tool cluster 10 may include additional robots, which may interact with each other such as by transferring wafers from one robot to another robot as well as moving wafers between various locations.

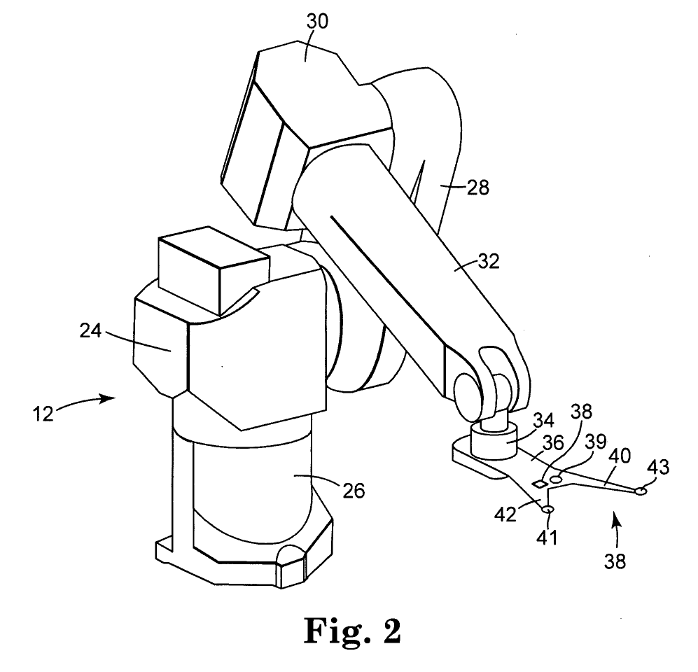

As shown in greater detail in FIG. 2, the exemplary robot 12 has a first body section 24 rotatably attached to a fixed base support 26. The robot 12 further includes a first link 28 pivotably attached to a first body 24 and a second body section 30. A second link 32 is also rotatably attached to the second body section 30. Positioned at an end of the second link 32 is a linkage 34, which is pivotably attached to the second link 32 at a first end and which is further rotatably attached to an end effector 36 and a second end. Also, a preferred vibration sensor device 38, which is described in detail below, is shown positioned on the end effector 36. It is noted that the robot 12 is of a type that is commercially available and other types of robots having various arrangements for controllably moving an end effector within a work environment may be used within the scope of the invention. The exemplary robot 12 has six degrees of movement in the x, y, z, yaw, pitch, and roll directions. Preferably, the robot 12 includes one or more motors (not shown) that can independently control the movement of the robot in the x, y, z, yaw, pitch, and roll directions. The motor(s) of the robot 12 are preferably electrically connected to one or more machine controllers (not shown) for directing the motion of the robot. A tool control point is preferably defined mathematically in the robot controller(s) as the point to which all translation and rotation commands are applied. Details of these motors and of the controller(s) are well known commercially.

For purposes of the present invention, an end effector is that portion of the robot structure that contacts objects to be transferred or otherwise handled in operation of the robot. Typically, the end effector of the robot is rotatably and/or pivotably coupled to a robotic arm. In a preferred embodiment, the robot end effector includes all components past the last robot major axis of rotation. Preferably, the end effector is independently moveable about at least two axes. End effectors typically comprise a plurality of wafer contact points, which can additionally function as wafer engagement mechanisms, depending on the design of the particular end effector. As shown, the outer end of the preferred end effector 36 is generally y-shaped comprising a base portion and two spaced apart finger portions 40 and 42 extending from the base portion, and having wafer contact points, which in this case also function as wafer engagement mechanisms, located at the base portion and at each of the finger portions.

End effector 36 is provided with vacuum engaging mechanisms 39, 41 and 43 that allow end effector 36 to releasably engage wafers for pick up, transfer, and drop off. Any suitable mechanism that provides such releasable engagement may alternatively be used to engage the wafers. Examples include mechanical edge gripping mechanism(s), differential pressure engaging mechanism(s) (e.g., vacuum engaging mechanisms or mechanism(s) that operate in whole or in part via the venturi/bernoulli effect), combinations of these, and the like. Edge gripping mechanism(s) are well known in the art and have been described, for example, in U.S. Pat. No. 6,256,555 B1 (Bacchi, et al.).

The vibration sensor device 38 is located on end effector 36 in a position wherein vibrations incurred by contact of the end effector with an object can be readily identified, without undue damping of the measurable vibration by the structure of the robot arm assembly. In other words, each of the wafer contact points and at least one vibration sensor device are operably connected so that when each wafer contact point comes in contact with a wafer, a signal indicative of the contact is generated. Optionally, a plurality of vibration sensor devices can be provided on the end effector. It has been found that contact of extended portions of the end effector, such as the finger portions shown in the drawing, institute vibrations that are readily transmitted to the rest of the end effector and can be readily measured, in some cases even by a single vibration sensor located at the base portion of the end effector. In contrast, contact made with the end effector at portions of the end effector that are closer to the support structure of the robot arm (i.e. in the base portion of the end effector) may be dampened by the sheer bulk of the structure and may cause the resulting vibrations to be more difficult to measure. Thus, portions of the end effector that are expected to make contact with an object in the work environment and which are at portions of the end effector having a width dimension greater than about 10 cm preferably have a vibration sensor device located within about 3 cm of the predicted contact location. Preferably, the vibration sensor device is located within about 3 cm of the wafer engagement mechanism at the base portion of the end effector. When a plurality of vibration sensor devices are incorporated on a wafer, they preferably are located generally proximally to contact points, and preferably within about 3 cm of a contact point.

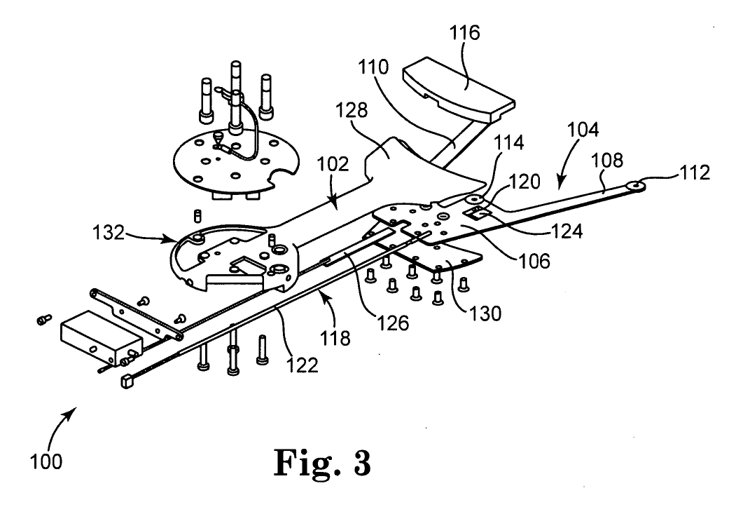

In FIG. 3, an exploded view of an exemplary end effector 100 in accordance with the present invention is shown. End effector 100 can be used with a robot such as the robot shown in FIG. 2, for example. As illustrated, end effector 100 comprises member 102 and fork 104. Fork 104 includes plate portion 106 and first and second arm portions, 108 and 110, extending outwardly from plate portion 106, as illustrated. Fork 104 also preferably includes carrying point 112 at an end of first arm 108, a similar carrying point at an end of second arm 110 (not visible in FIG. 3), and a carrying point 114 positioned on plate portion 106. These carrying points are preferably designed to support and hold a payload such as a wafer or the like and may comprise buttons or vacuum cups or the like. In this regard, end effector preferably includes block 116 that can work together with the carrying points to center and position the payload. In one embodiment, block 116 preferably functions as a centering hard stop to position a wafer or the like.

In accordance with the present invention, end effector 100 includes vibration sensor 118, which includes transducer 120 and lead 122, as shown. Preferably, end effector 100 is designed so that transducer 120 is sonically coupled with fork 104. That is, transducer 120 is preferably integrated with fork 104 so that transducer 120 can sense vibrations caused by contact between an object and fork 104 as well as vibrations related to movement of a robot to which end effector 100 is attached. Sensed vibrations can be communicated to a control or analysis system (not shown) by lead 122.

As illustrated, transducer 120 is positioned in window 124 of plate portion 106, which is preferably at least partially filled or coated with epoxy or cement or the like to effectively embed transducer 120 in plate portion 106. In accordance with the present invention, transducer 120 can be attached to fork 104 in any way that sonically couples transducer to fork 104 including mechanical, adhesive, and/or magnetic means.

As shown, transducer 120 is spaced from carrying point 114. Preferably, the spacing of transducer 120 from carrying point 114 is determined by considering the performance characteristics of the particular transducer used, the vibration characteristics of the fork 104 and the type of vibration event desired to be sensed by transducer 120. In general, sensitivity of transducer 120 to vibrations caused by contacting carrying point 114 increases as spacing between transducer 120 and carrying point 114 decreases. By using this concept, an empirical approach can be used to determine an optimized location for transducer 120 with respect to carrying point 114 for sensing vibrations originating at carrying point 114 as well as for sensing vibrations originating at any other location or source. That is, transducer 120 is preferably able to simultaneously sense vibrations coming from more than one source or location.

It is contemplated that transducer 120 may be positioned near any desired carrying point or any other location on end effector 100, robot, or work environment. Moreover, any number of transducers may be used at any number of locations. For example, distinct vibration sensors may be used on an end effector and a robot arm in accordance with the present invention.

Also, as illustrated, end effector 100 preferably includes proximity sensor 126. Proximity sensor 126 is preferably designed to sense the presence or absence of a payload such as a wafer or the like. Exemplary sensors include those of the capacitance type.

Plate 106 is preferably designed to be attached to member 102 at first end 128. As shown, plate 106 can be clamped between end 128 and clamping plate 130.

Member 102 is also designed to be connectable to a robot arm at second end 132 of member 102.

A vibration sensor may be selected from any known or future developed sensor, device, or system that can sense vibrations. In accordance with the present invention, a vibration sensor is preferably capable of sensing vibrations related to contact events including picking up and delivering a payload such as a wafer or the like and touching or contact between some portion of the robot and some portion of the work environment of the robot. Vibration sensors that can be used include those that can be characterized as piezoelectric, capacitance, null-balance, strain gage, resonance beam, piezoresistive and magnetic induction sensors. It is contemplated that sensors based on MEMS technology, a micro-machining technology that allows for a much smaller device and thus package design, can also be used in accordance with the present invention.

For a particular application, factors that can be used to select a vibration sensor include the required measurement and frequency range, accuracy, sensitivity, and tolerance to ambient conditions. Accuracy is related to the amount of allowable error over the full measurement range of the device. Sensitivity generally relates to the effect a force in a different direction to the one being measured can have on the measurement. Exposure to temperature should be considered, as well as the maximum shock and vibration the vibration sensor can handle.

Sensors may include one or more sensing elements, packaged transducers, or sensor systems or instruments. Sensors may also include features such as totalizing functions, local or remote display functions, and data recording or analysis function. Sensors may provide analog outputs such as voltage, current or frequency. Sensor may also provide digital outputs such as parallel, serial, and any similarly functioning signals.

An example of a vibration sensor is one made of a material that exhibits the piezo effect, such as ceramic or quartz based construction Preferably this sensor is embedded in the end effector structure to provide a flush surface that does not present obstruction with respect to moving parts. Additionally, it has been found that an embedded sensor provides superior sensing capabilities relative to a surface mounted sensor. Preferably, the sensor is placed in a receptacle structure within the end effector, and is overcoated by a resin, such as an epoxy resin, to provide superior retention of the sensor on the end effector.

As mentioned above, the vibration sensor device 38 can be used as part of a system to accurately detect features, such as a reference structure, of a work environment of a robot by contacting features or objects in the work environment, sending a signal indicating contact, and identifying the position of the end effector at the occurrence of the contact. In order to carry out this detection, the measurable vibrations (i.e. vibration frequency and/or amplitude levels) made by a robot end effector when in motion and also made when contacting an object within a work environment must be measured and compared in order to be able to differentiate the normal vibrations of a robot end effector in motion from the vibrations that occur when the robot end effector contacts an object within a work environment. In this characterizing method as discussed above, the characteristic vibration of the robot end effector when in motion is first observed by moving the robot end effector through a predetermined range of motion and measuring the observed vibration of the robot end effector at predetermined portions of this moving step. Preferably, these observations are carried out with or both with and without an actual or mock payload being held by the end effector. In a particularly preferred embodiment, the observations are made to identify the “worst case” background noise situation, where the joint motion, relative position of joints, and other factors involved in robot movement of the particular robot involved generate the most background noise for that particular robot. Identification of observed vibration for the worst case situation is particularly advantageous, because this allows for identification of a base line vibration frequency and/or amplitude level that can be used for comparison at any position of the end effector.

The robot end effector is then moved through a predetermined range of motion while causing the robot end effector to contact an object in the work environment of the robot, and the vibration of the robot end effector is measured at predetermined portions of the motion. Preferably, again, these observations are carried out with or both with and without an actual or mock payload being held by the end effector. In a preferred embodiment, this observation is not carried out on a continual basis, but is carried out only during short durations where a contact with an object is predicted. The observed vibration during ordinary motion (i.e. background noise vibration) of the end effector is compared with the observed vibration of the robot end effector when colliding with an object. Through this comparison, one can discriminate between ordinary operation vibration and vibration that occurs as a result of contact. Preferably an automatic monitoring function is established to determine when to generate a signal indicative of the contact of the robot end effector with the object. For example, one or more vibration frequencies can be identified for monitoring to determine when a signal should be sent that is indicative of contact of the robot end effector with the object without undue background noise from motion of the robot end effector. As a specific example, for certain robots it has been found that the identification of a collision can be accomplished by monitoring only vibrations that are measured above a certain frequency or within a determined frequency range, such as by monitoring vibration frequencies of from about 5,000 to about 10,000 Hz. The monitoring and signal generation can be automatically established by filtering, using for example, analog circuitry or digital signal processing.

After characterization of the vibrations of the robot end effector, the robot end effector equipped with a vibration sensitive sensor can be used to locate contact points of the end effector with objects, or the location of the end effector when the robot experiences an adverse robot end effector motion event. When a signal is generated indicating either contact or an adverse robot end effector motion event, the position of end effector at the point of contact or the event is recorded by any appropriate technique. In a preferred technique, the relative position of all joints all joints of robot are recorded by a monitoring system (as conventionally used with robots) upon occurrence of the collision or the event.

The complete location of an object in the work environment of the robot can be identified by contacting the object a plurality of times at a plurality of contact points, and recording the location of the end effector at each contact as discussed above. In an object location operation, the end effector is preferably provided with an actual or mock payload. The robot end effector is moved in a manner so that it contacts an object in the work environment of the robot. Upon contact, vibrations are induced in the end effector that are measurable by the vibration sensor. This vibration is compared to the background vibration previously measured for the end effector in this portion of the range of motion, and a signal indicative of the position of the contact with respect to the object is generated. The information so collected can be used to teach the robot the locations of the contact in the work environment of the robot.

The robot end effector having an actual or mock payload gripped thereby can be run through a series of manipulations, including approaching an object to be located from multiple angles in the X, Y and Z planes. Alternatively or additionally, an actual or mock payload can be placed at a desired location in the work environment, such as in a FOUP or station, and the empty end effector is brought into proximity with the payload and contacted to provide information indicating the location of the payload. As above, a series of manipulations, including approaching an object to be located from multiple angles in the X, Y and Z planes can be carried out to provide information indicating the location of the payload. In a preferred technique, the end effector is manipulated so that each anticipated engagement point of the end effector with the payload (when properly engaged) is separately contacted with the payload, so that proper orientation of the end effector can be clearly mapped out. Through collection of this data, one can determine an object's location in the robot's frame of reference. Having mapped out the location of objects and features, one can use this information to determine the robot's location and orientation in relation to the contacted object. Thus, through a process of identifying the location of various stations and objects in the work environment of the robot, one can carry out an automated approach for determining locations that are recorded and can be used as reference by a wafer transfer robot. The data accumulated during a series of contacting steps by the robot end-effector can be utilized by a controller to provide a precise calibrated control program for future operation of the robot.

Optionally, additional sensors may be used in conjunction with the vibration sensors described herein to provide sensing of one or more different aspects of position or contact of the end effector relative to features or objects in the work environment of the robot. For example, the end effector can optionally additionally be provided with one or more light sensors, proximity sensors or touch sensors to provide sensing of contact or proximity of the end effector with respect to one or more dimensions or coordinate position determinations.

Thus, the present invention provides a teaching method which enables a multi-axis robot machine to automatically precisely locate physical, fixed objects within its working environment. This method is particularly suited towards robotic applications where a multi-axis robot operates within a defined environment and moves to or interacts with various process station locations. It enables the robot to automatically locate these stations with high precision by touching known and distinct features on each station.

Numerous characteristics and advantages of representative embodiments of the invention have been set forth in the foregoing description. It is to be understood, however, that while particular forms or embodiments of the invention have been illustrated, various modifications, including modifications to shape, and arrangement of parts, and the like, can be made without departing from the spirit and scope of the invention.

What is claimed is:

1. A method of characterizing the vibration of a robot end effector when in motion and when contacting an object within a work environment of the robot, the method comprising the steps of:
a) providing a vibration sensitive sensor on a robot end effector;
b) moving the robot end effector through a predetermined range of motion and measuring the observed vibration of the robot end effector at predetermined portions of this moving step b);
c) moving the robot end effector through a predetermined range of motion while causing the robot end effector to contact an object in the work environment of the robot, and measuring the observed vibration of the robot end effector at predetermined portions of moving and contacting step c);
d) comparing the observed vibration of step b) with the observed vibration of step c) and identifying one or more vibration frequencies to monitor to provide a signal indicative of the position of the contact of the robot end effector with the object without undue background noise from motion of the robot end effector.

2. A method of teaching a robot a position within a work environment of the robot, the method comprising the steps of:
providing a robot end effector that has been characterized in accordance with the method of claim 1;
causing the robot end effector to contact an object in the work environment of the robot;
generating a signal indicative of the contact of the robot end effector with the object; and
recording the end effector position in a manner that can be translated to the robot's frame of reference at the occurrence of contact using the recorded end effector position to teach the robot the location of the contact in its frame of reference.

3. The method of claim 2, wherein the object is contacted a plurality of times at a plurality of contact points to determine an object's location and orientation in the robot's frame of reference.

4. A method of determining an adverse robot end effector motion event comprising the steps of:
i) providing a robot end effector that has been characterized in accordance with the method of claim 1;
ii) causing the robot end effector to move through a predetermined range of motion in the work environment of the robot while monitoring the observed vibration of the robot end effector;
iii) comparing the observed vibration of the monitored motion with the observed vibration of step b) of claim 1; and
iv) generating a signal indicative of a variance in the compared vibrations indicative of an adverse robot end effector motion event, and recording the end effector's position in a manner that can be translated to the robot's frame of reference at the occurrence of the event.

5. The method of claim 4, wherein the adverse robot end effector motion event is a collision of the robot end effector with an object in the work environment of the robot.

6. The method of claim 4, wherein the adverse robot end effector motion event is a mechanical failure of the robot end effector.

7. A robot end effector vibration sensor system for providing positional information about a movable robot end effector in a work environment of the robot, the vibration sensor system comprising:
a robot having a robot end effector with a vibration sensitive sensor located thereon, the robot end effector having been characterized in accordance with the method of claim 1; and
a control system that uses information comprising information from the vibration sensitive sensor to determine the position of the robot end effector of the robot in the work environment of the robot.

8. A vibration sensitive robot, the robot comprising;
at least one robot end effector capable of being controllably moved within a work environment of the robot;
at least one vibration sensor device positioned on the robot end effector of the robot, which at least one vibration sensor device outputs a signal indicative of a contact of the robot end effector when contacting at least a portion of the work environment.

9. The vibration sensitive robot of claim 8, wherein the end effector comprises a plurality of wafer contact points, and wherein each of the wafer contact points and the at least one vibration sensor device are operably connected so that when each wafer contact point comes in contact with a wafer, a signal indicative of the contact is generated.

10. The vibration sensitive robot of claim 8, wherein the end effector is generally y-shaped comprising a base portion and two spaced apart finger portions extending from the base portion, and having a wafer contact point located at the base portion and at each of the finger portions.

11. The vibration sensitive robot of claim 9, wherein the vibration sensor device is located within about 3 cm of the wafer contact point at the base portion of the end effector.

12. The vibration sensitive robot of claim 8, wherein the end effector comprises wafer engagement mechanisms that are vacuum engaging mechanisms.

13. A robotic system, the robotic system comprising;
a work environment;
a robot end effector vibration sensor system of claim 7, wherein the robot end effector is positioned at least partially within the work environment, wherein the robot end effector vibration sensor system is capable of providing information indicative of the position of at least a portion of the robot end effector of the robot in the work environment.
